(19) United States
(12) Patent Application Publication
(10) Pub. No.: US 2025/0036338 A1
(43) Pub. Date: Jan. 30, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Tomomichi ADEGAWA, Kanagawa (JP)

(73) Assignee: FUJIFILM Business Innovation Corp., Tokyo (JP)

(21) Appl. No.: 18/443,334

(22) Filed: Feb. 16, 2024

(30) Foreign Application Priority Data
Jul. 25, 2023 (JP) 2023-121153

(51) Int. Cl. G06F 3/12

(52) U.S. Cl. CPC G06F 3/1275; G06F 3/1222; G06F 3/1238; G06F 3/1292

(57) ABSTRACT

An information processing system includes one or more processors configured to receive registration, by a user, of cases waiting for processing that are cases for which predetermined additional processing is scheduled to be executed in a target apparatus for any of a plurality of types of cloud services, and execute processing of preferentially displaying, as selection candidates, a list of cloud services in which the cases waiting for processing are registered among the plurality of types of cloud services on the target apparatus in a case where the user selects the cloud services in which the corresponding cases waiting for processing are registered from the plurality of types of cloud services in the target apparatus in order to execute the additional processing.

### CROSS-REFERENCE TO RELATED APPLICATIONS

This application is based on and claims priority under 35 USC 119 from Japanese Patent Application No. 2023-121153 filed Jul. 25, 2023.

### BACKGROUND

### (i) Technical Field

The present disclosure relates to an information processing system and a non-transitory computer readable medium.

### (ii) Related Art

Japanese Unexamined Patent Application Publication No. 2020-166377 discloses an image forming apparatus that aims to provide a mechanism for suitably updating an application installed in the image forming apparatus in a case where a service that is not supported by the application is included in services accessible by a user.

The image forming apparatus includes an authenticating unit that receives authentication information of a user to execute authentication, a determining unit that determines whether or not information of the service accessible by the user, which is included in the authentication result, is supportable by the application installed in the image forming apparatus when the authentication by the authenticating unit is successful, and an updating control unit that display a message related to updating of the application on a display unit when it is determined that the service accessible by the user is not supportable by the application.

### SUMMARY

Incidentally, in recent years, for the purpose of improving efficiency of a series of tasks by a plurality of users, a workflow system that is a system for performing approval, circulation, or the like of an application form, a notification form, or the like digitized in accordance with a predetermined workflow has been operated. Note that, the term “workflow” as used herein means “a flow or a set of a series of tasks that are in conjunction with each other in accordance with processing by a user”.

On the other hand, in the workflow system, tasks may be performed by using a plurality of types of cloud services. In this case, when a plurality of users share a single target apparatus, the target apparatus may cooperate with a large number of cloud services. Note that, examples of the type of the cloud services include a business-related service represented by a customer management system, a business support system, a sales management system, or the like, a human resource-related service represented by a human resources and salary system or the like, and a whole-office related service represented by a business chat, a web conference, or the like.

In this case, a user who uses the target apparatus needs to select a desired service from among the large number of cloud services, and there is a problem in that much labor is required for the selection.

Aspects of non-limiting embodiments of the present disclosure relate to an information processing system and a non-transitory computer readable program that can more easily select a desired cloud service as compared with a case where a cloud service in which a case waiting for processing is registered is not preferentially displayed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to receive registration, by a user, of cases waiting for processing that are cases for which predetermined additional processing is scheduled to be executed in a target apparatus for any of a plurality of types of cloud services, and execute processing of preferentially displaying, as selection candidates, a list of cloud services in which the cases waiting for processing are registered among the plurality of types of cloud services on the target apparatus in a case where the user selects the cloud services in which the corresponding cases waiting for processing are registered from the plurality of types of cloud services in the target apparatus in order to execute the additional processing.

### BRIEF DESCRIPTION OF THE DRAWINGS

An exemplary embodiment of the present disclosure will be described in detail based on the following figures, wherein:

FIG. 1 is a block diagram illustrating an example of a configuration of an information processing system according to an exemplary embodiment;

FIG. 2 is a block diagram illustrating an example of a hardware configuration of a terminal apparatus according to the exemplary embodiment;

FIG. 3 is a block diagram illustrating an example of a configuration of an electrical system of an image forming apparatus according to the exemplary embodiment;

FIG. 4 is a block diagram illustrating an example of a functional configuration of the information processing system according to the exemplary embodiment;

FIG. 5 is a schematic diagram illustrating an example of a configuration of a license information database according to the exemplary embodiment;

FIG. 6 is a schematic diagram illustrating an example of a configuration of a processing-waiting case database according to the exemplary embodiment;

FIG. 7 is a flowchart illustrating an example of first information processing according to the exemplary embodiment;

FIG. 8 is a front view illustrating an example of a service designation screen according to the exemplary embodiment;

FIG. 9 is a flowchart illustrating an example of second information processing according to the exemplary embodiment;

FIG. 10 is a front view illustrating an example of a service designation screen according to the exemplary embodiment;

FIG. 11 is a front view illustrating an example of a processing-waiting case presentation screen according to the exemplary embodiment; and

FIG. 12 is a front view illustrating another example of the service designation screen according to the exemplary embodiment.

### DETAILED DESCRIPTION

Hereinafter, modes for carrying out the technology of the present disclosure will be described in detail with reference to the drawings. Note that, here, a case where the technology of the present disclosure is applied to an information processing system that implements the above-described workflow will be described.

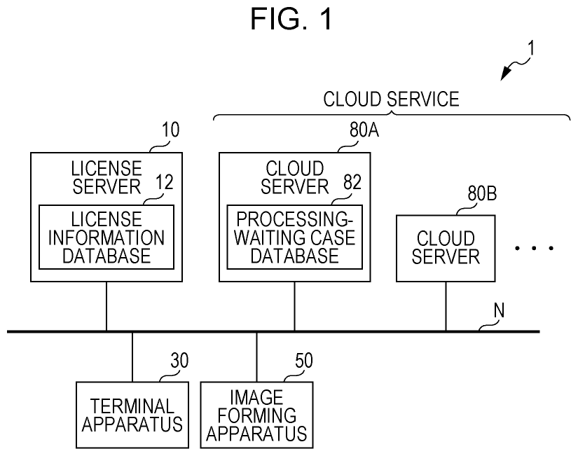

First, a configuration of an information processing system 1 according to the present exemplary embodiment will be described with reference to FIG. 1. FIG. 1 is a block diagram illustrating an example of the configuration of the information processing system 1 according to the present exemplary embodiment.

As illustrated in FIG. 1, the information processing system 1 according to the present exemplary embodiment includes a license server 10, a terminal apparatus 30, an image forming apparatus 50, and a plurality of cloud servers 80A, 80B, and . . . . Note that, hereinafter, the cloud servers 80A, 80B, and . . . are collectively referred to simply as “cloud servers 80” in a case where the cloud servers are described without distinction.

Examples of the license server 10, the terminal apparatus 30, and the cloud servers 80 include various kinds of stationary information processing apparatuses such as a personal computer and a server computer. However, the present invention is not limited to this form, and various portable information processing apparatuses such as a tablet terminal and a portable information terminal may be applied as the license server 10, the terminal apparatus 30, and the cloud servers 80. In addition, in the present exemplary embodiment, a digital multifunction peripheral having an image printing function, an image reading function, an image transmitting function, and the like is applied as the image forming apparatus 50. However, the present invention is not limited to this form, and another image forming apparatus such as an image forming apparatus having only an image printing function and an image reading function may be applied as the image forming apparatus 50.

The license server 10, the terminal apparatus 30, the image forming apparatus 50, and the cloud servers 80 are connected to each other via a network N, and these apparatuses can communicate with each other via the network N. Note that, in the present exemplary embodiment, although a combination of a public communication line such as the Internet or a telephone line network and an in-company communication line in a company such as a local area network (LAN) or a wide area network (WAN) is applied as the network N, the present invention is not limited to this form. For example, only one of the public communication line and the in-company communication line may be applied as the network N. In addition, in the present exemplary embodiment, although a combination of wired and wireless communication lines is applied as the network N, the present invention is not limited to this form. Only a wireless communication line may be applied, or only a wired communication line may be applied.

Note that, although only one license server 10, one terminal apparatus 30, and one image forming apparatus 50 are illustrated in FIG. 1 in order to avoid complexity, the present invention is not limited thereto. For example, a system including a plurality of at least one of these apparatuses may be applied as the information processing system 1.

The information processing system 1 according to the present exemplary embodiment is configured to provide, to a user, a plurality of types of cloud services available in cooperation with the image forming apparatus 50, and each of the plurality of cloud servers 80 according to the present exemplary embodiment is configured to provide these cloud services.

In order to use the cloud services according to the present exemplary embodiment, it is necessary to enter into license agreements with providers of the corresponding services. In the license server 10 according to the present exemplary embodiment, as illustrated in FIG. 1, a license information database 12, to be described in detail later, in which information indicating a user who enters into a license agreement is registered for each cloud service targeted by the information processing system 1 is constructed.

On the other hand, as will be described later, the information processing system 1 according to the present exemplary embodiment can register, in the corresponding cloud server 80, cases waiting for processing that are cases for which predetermined additional processing is scheduled to be executed in the target apparatus for any of the plurality of types of cloud services.

In each of the cloud servers 80 according to the present exemplary embodiment, as illustrated in FIG. 1, a processing-waiting case database 82, to be described in detail later, for registering the above-described case waiting for processing is constructed.

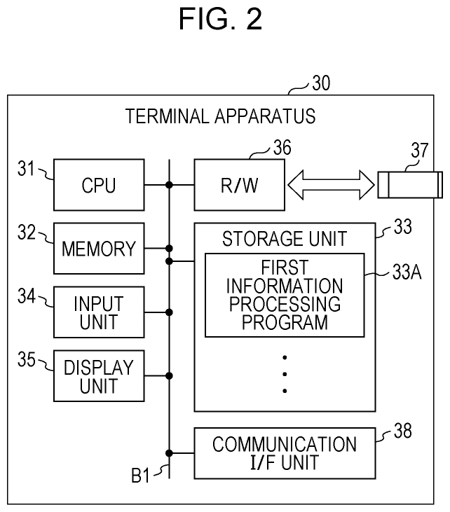

Next, a configuration of the terminal apparatus 30 according to the present exemplary embodiment will be described with reference to FIG. 2. FIG. 2 is a block diagram illustrating an example of a hardware configuration of the terminal apparatus 30 according to the present exemplary embodiment.

As illustrated in FIG. 2, the terminal apparatus 30 according to the present exemplary embodiment includes a central processing unit (CPU) 31 as a processor, a memory 32 as a temporary storage area, a nonvolatile storage unit 33, an input unit 34 such as a keyboard and a mouse, a display unit 35 such as a liquid crystal display, a medium reading and writing device (R/W) 36, and a communication interface (I/F) unit 38. The CPU 31, the memory 32, the storage unit 33, the input unit 34, the display unit 35, the medium reading and writing device 36, and the communication I/F unit 38 are connected to each other via a bus B1. The medium reading and writing device 36 reads out information written in a recording medium 37 and writes information to the recording medium 37.

The storage unit 33 according to the present exemplary embodiment is implemented by a hard disk drive (HDD), a solid state drive (SSD), a flash memory, or the like. The storage unit 33 as a storage medium stores a first information processing program 33A.

The first information processing program 33A is stored (installed) in the storage unit 33 in such a manner that the recording medium 37 in which the first information processing program 33A is written is connected to the medium reading and writing device 36 and the medium reading and writing device 36 reads out the first information processing program 33A from the recording medium 37. The CPU 31 sequentially executes processes included in the first information processing program 33A by appropriately reading out the first information processing program 33A from the storage unit 33 and loading the first information processing program 33A into the memory 32.

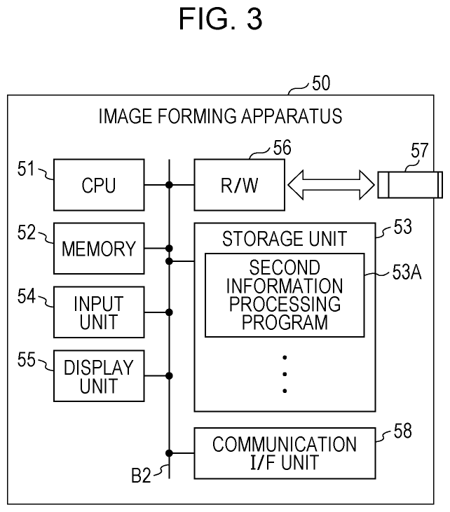

Next, a configuration of the image forming apparatus 50 according to the present exemplary embodiment will be described with reference to FIG. 3. FIG. 3 is a block diagram illustrating an example of a configuration of an electrical system of the image forming apparatus 50 according to the present exemplary embodiment.

As illustrated in FIG. 3, the image forming apparatus 50 according to the exemplary embodiment includes a CPU 51 as a processor, a memory 52 as a temporary storage area, a nonvolatile storage unit 53, an input unit 54 such as various switches, a display unit 55 such as a liquid crystal display, a medium reading and writing device (R/W) 56, and a communication I/F unit 58. The CPU 51, the memory 52, the storage unit 53, the input unit 54, the display unit 55, the medium reading and writing device 56, and the communication I/F unit 58 are connected to each other via a bus B2. The medium reading and writing device 56 reads out information written in a recording medium 57 and writes information to the recording medium 57.

The storage unit 53 according to the present exemplary embodiment is implemented by an HDD, an SSD, a flash memory, or the like. The storage unit 53 as a storage medium stores a second information processing program 53A. The second information processing program 53A is stored (installed) in the storage unit 53 in such a manner that the recording medium 57 in which the second information processing program 53A is written is connected to the medium reading and writing device 56 and the medium reading and writing device 56 reads out the second information processing program 53A from the recording medium 57. The CPU 51 sequentially executes processes included in the second information processing program 53A by appropriately reading out the second information processing program 53A from the storage unit 53 and loading the program into the memory 52.

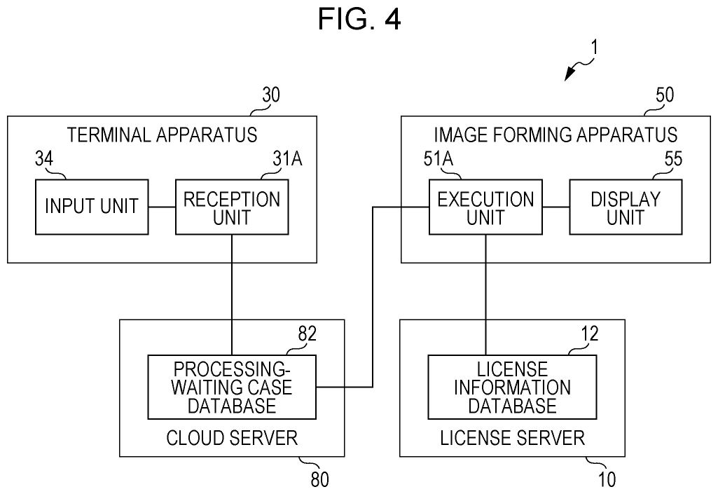

Next, a functional configuration of the information processing system 1 according to the present exemplary embodiment will be described with reference to FIG. 4. FIG. 4 is a block diagram illustrating an example of the functional configuration of the information processing system 1 according to the present exemplary embodiment.

As illustrated in FIG. 4, the terminal apparatus 30 according to the present exemplary embodiment includes a reception unit 31A, and the image forming apparatus 50 includes an execution unit 51A. The CPU 31 of the terminal apparatus 30 functions as the reception unit 31A by executing the first information processing program 33A. In addition, the CPU 51 of the image forming apparatus 50 functions as the execution unit 51A by executing the second information processing program 53A.

As partially described above, the reception unit 31A of the terminal apparatus 30 according to the present exemplary embodiment receives registration, by the user, of cases waiting for processing that are cases for which predetermined additional processing is scheduled to be executed in the target apparatus for any of the plurality of types of cloud services.

In the present exemplary embodiment, processing of adding predetermined additional information is applied as the additional processing. In addition, in the present exemplary embodiment, the image forming apparatus 50 having the image reading function is applied as the target apparatus, and scanned image information read by the image reading function of the image forming apparatus 50 is applied as the additional information. However, the present invention is not limited to this form, and processing of obtaining approval of a predetermined approver for the use of any cloud service during execution of a workflow using the cloud service may be applied as the additional processing. The additional information in this form may be, for example, information indicating sealing by the approver. Note that, the target apparatus in this case or the like is not necessarily limited to the image forming apparatus 50, and for example, the terminal apparatus 30 according to the present exemplary embodiment may be applied as the target apparatus.

On the other hand, in a case where the user selects, from among the plurality of types of cloud services in the target apparatus, a cloud service in which a corresponding case waiting for processing is registered in order to execute the additional processing, the execution unit 51A of the image forming apparatus 50 according to the present exemplary embodiment executes processing of preferentially displaying, as selection candidates, a list of cloud services in which cases waiting for processing are registered among the plurality of types of cloud services on the target apparatus. Although the execution unit 51A according to the present exemplary embodiment specifies the cloud service in which the case waiting for processing is registered while referring to the processing-waiting case database 82 registered in the cloud server 80, the present invention is not limited thereto. For example, when the user registers the case waiting for processing by using the terminal apparatus 30, the cloud service in which the case waiting for processing is registered may be specified in such a manner that information indicating the case waiting for processing is registered in the terminal apparatus 30 together with information indicating the corresponding cloud service and these pieces of information are read out.

In particular, the execution unit 51A according to the present exemplary embodiment executes the processing of displaying the list of cloud services by using cloud services available to a login user who logs in to the target apparatus as targets to be preferentially displayed. Although the execution unit 51A according to the present exemplary embodiment specifies the cloud services available to the login user while referring to the license information database 12 registered in the license server 10, the present invention is not limited thereto. For example, when the user enters into a license agreement for the cloud service by using the terminal apparatus 30, the cloud services available to the login user may be specified in such a manner that information indicating that the user enters into the license agreement is registered in the terminal apparatus 30 together with the information indicating the corresponding cloud service and the execution unit 51A reads out these pieces of information.

In addition, the execution unit 51A according to the present exemplary embodiment executes the processing of displaying the list of cloud services by using cloud services in which cases waiting for processing registered by the login user are registered as the targets to be preferentially displayed. Further, the execution unit 51A according to the present exemplary embodiment executes processing of displaying, as the selection candidates, a list of only cloud services in which the cases waiting for processing are registered on the target apparatus.

Note that, although processing immediately after issuance of a form by a workflow is applied as the processing by the case waiting for processing in the present exemplary embodiment, the present invention is not limited thereto. For example, as in the case where the approval by the approver is received as described above, the processing in the middle of the execution of the workflow may be applied as the processing by the case waiting for processing. In addition, regardless of the processing by the workflow, processing by a sporadic case in which some additional processing is scheduled to be executed in the target apparatus may be applied as the processing by the case waiting for processing.

Further, in a case where a desired cloud service is selected by the user from among the selection candidates displayed in the list, the execution unit 51A according to the present exemplary embodiment executes processing of displaying, as the selection candidates, a list of only cases waiting for processing registered by the user among the cases waiting for processing registered in the selected cloud service on the target apparatus.

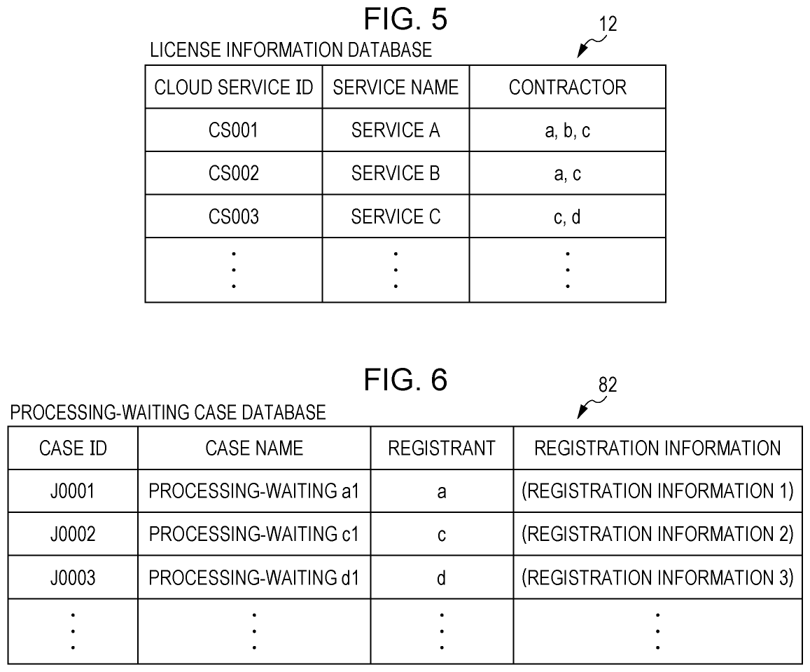

Next, the license information database 12 according to the present exemplary embodiment will be described with reference to FIG. 5. FIG. 5 is a schematic diagram illustrating an example of a configuration of the license information database 12 according to the present exemplary embodiment.

As described above, the license information database 12 according to the present exemplary embodiment is a database in which the information indicating the users who enters into the license agreement is registered. As an example, as illustrated in FIG. 5, the license information database 12 according to the present exemplary embodiment stores pieces of information of cloud service identification (ID), service names, and contractors in association with each other.

The cloud service ID is information that is given in advance as a different one for each of the cloud services in order to individually specifying the cloud services supported by the information processing system 1. In addition, the service name is information indicating a name of the corresponding cloud service, and the contractor is information indicating the user who enters into the license agreement with the provider of the corresponding cloud service.

In the example illustrated in FIG. 5, a cloud service to which “CS001” is given as the cloud service ID is named “service A” and has three contractors a, b, and c.

Next, the processing-waiting case database 82 according to the present exemplary embodiment will be described with reference to FIG. 6. FIG. 6 is a schematic diagram illustrating an example of a configuration of the processing-waiting case database 82 according to the present exemplary embodiment.

The processing-waiting case database 82 according to the present exemplary embodiment is a database in which the above-described cases waiting for processing (hereinafter, also referred to as “processing-waiting cases”) are registered. As an example, as illustrated in FIG. 6, the processing-waiting case database 82 according to the present exemplary embodiment stores pieces of information of case IDs, case names, registrants, and registration information in association with each other.

The case ID is information given in advance as a different ID for each of the processing-waiting cases in order to individually specify the corresponding processing-waiting cases. In addition, the case name is information indicating a name of the corresponding case waiting for processing, the registrant is information indicating the user who enters into the corresponding processing-waiting case, and the registration information is information indicating the corresponding processing-waiting case itself.

In the example illustrated in FIG. 6, a processing-waiting case to which “J0001” is given as the case ID is named “processing-waiting al”, and has a registrant a.

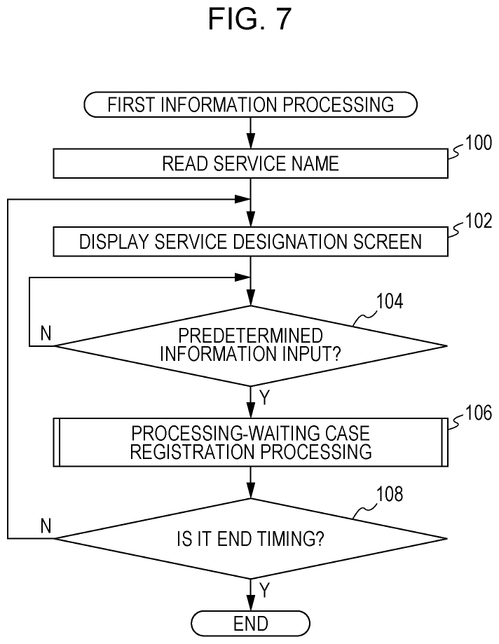

Next, actions and effects of the information processing system 1 according to the present exemplary embodiment will be described with reference to FIGS. 7 to 11. Note that, here, in order to avoid complexity, a case where the license information database 12 has been constructed will be described.

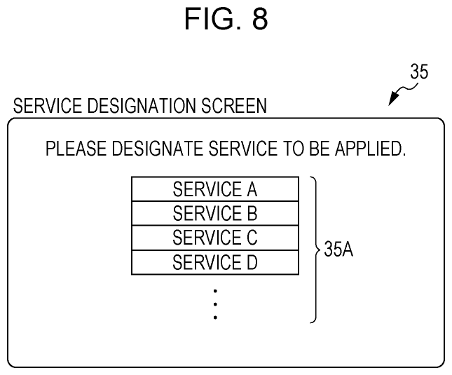

First, actions and effects of the terminal apparatus 30 in a case where first information processing is executed will be described with reference to FIGS. 7 and 8. FIG. 7 is a flowchart illustrating an example of the first information processing according to the present exemplary embodiment.

The first information process according to the present exemplary embodiment is executed by the CPU 31 of the terminal apparatus 30 executing the first information processing program 33A in a case where the user of the terminal apparatus 30 inputs an instruction to start the execution of the first information processing in order to register the above-described processing-waiting case.

In step 100 of FIG. 7, the CPU 31 acquires the names of all the cloud services supported by the information processing system 1 by reading out all the service names from the license information database 12 of the license server 10.

In step 102, the CPU 31 performs control such that a service designation screen having a predetermined configuration is displayed by the display unit 35, by using the acquired names of all the cloud services, and in step 104, the CPU 31 waits until predetermined information is input. FIG. 8 illustrates an example of the service designation screen according to the present exemplary embodiment.

As illustrated in FIG. 8, a message prompting the user to designate a cloud service to be applied is displayed on the service designation screen according to the present exemplary embodiment. In addition, on the service designation screen according to the present exemplary embodiment, pieces of information (hereinafter, referred to as “service name information”) 35A indicating the acquired names of the cloud services are displayed in a list in a state of being able to be designated.

When the service designation screen is displayed on the display unit 35 of the terminal apparatus 30, the user designates, via the input unit 34, a display area for the name of the cloud service to be applied, among the pieces of displayed service name information 35A. When any of the display areas is designated by the user, an affirmative determination is made in step 104, and the processing proceeds to step 106.

In step 106, the CPU 31 executes processing of registering the above-described processing-waiting case using the designated cloud service in the processing-waiting case database 82 of the corresponding cloud server 80. In this processing, the above-described case ID and case name are determined for the processing-waiting case input by the user by the CPU 31, and these pieces of information, information that the user is the registrant, and information indicating the processing-waiting case itself are registered in the processing-waiting case database 82.

In step 108, the CPU 31 determines whether or not it is a predetermined end timing as a timing at which the present first information processing is ended. In the case of a negative determination, the processing returns to step 102, and in the case of an affirmative determination, the present first information processing is ended. Note that, in the present exemplary embodiment, a timing at which an instruction input instructing to end the first information processing is given by the user is applied as the end timing, but it goes without saying that the present invention is not limited thereto.

By the above-described first information processing, the processing-waiting case database 82 illustrated in FIG. 6 is constructed as an example.

Note that, although it has been described that the list of all the cloud services targeted by the information processing system 1 is displayed on the service designation screen in the first information processing, the present invention is not limited thereto. For example, only cloud services for which the user who logs in to the terminal apparatus 30 enters into the license agreement may be displayed on the service designation screen while referring to the license information database 12 of the license server 10. In addition, in this form, when there are a plurality of cloud services to be displayed, an order of displaying the cloud services may be determined in accordance with a predetermined condition, such as an order of earlier license agreement dates by the login user or an order of higher use frequencies by the login user.

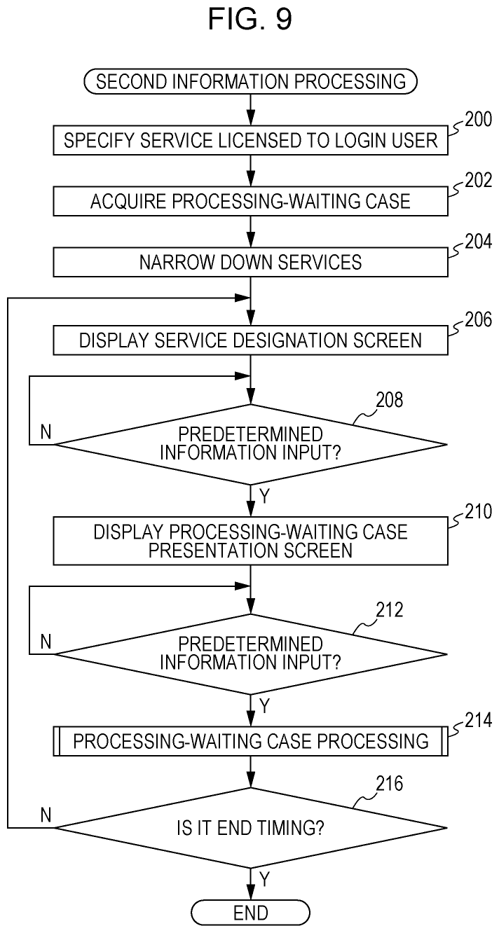

Next, actions and effects of the image forming apparatus 50 in a case where the second information processing is executed will be described with reference to FIG. 9 to FIG. 11. FIG. 9 is a flowchart illustrating an example of the second information processing according to the present exemplary embodiment.

The second information process according to the present exemplary embodiment is executed by the CPU 51 of the image forming apparatus 50 executing the second information processing program 53A in a case where the user moves to an installation location of the desired image forming apparatus 50 and is instructed to execute the additional processing from a menu displayed on the display unit 55 of the image forming apparatus 50 in order to execute the additional processing according to the above-described processing-waiting case. Note that, here, in order to avoid complexity, a case where the user logs in to the image forming apparatus 50 in advance and the login user is specified by the image forming apparatus 50 will be described.

In step 200 of FIG. 9, the CPU 51 specifies a cloud service (hereinafter, referred to as a “contracted service”) with which the login user enters into the license agreement while referring to the license information database 12 of the license server 10.

In step 202, the CPU 51 reads out all pieces of information (hereinafter, referred to as “pieces of processing-waiting case information”) from the processing-waiting case database 82 of the cloud server 80 that executes the contracted service. In step 204, the CPU 51 narrows down the specified contracted services to only contracted services for which the processing-waiting cases registered by the login user are included in the pieces of processing-waiting case information. The contracted services narrowed down by this narrowing-down are hereinafter referred to as “target contracted services”.

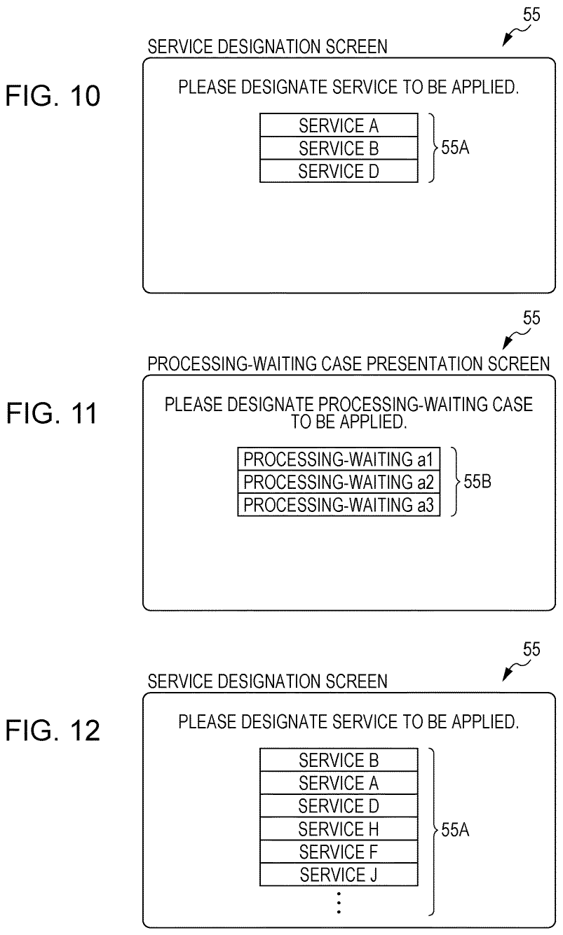

In step 206, the CPU 51 performs control such that a service designation screen having a predetermined configuration is displayed by the display unit 55 by using pieces of information indicating the target contracted services (the service names in the present exemplary embodiment), and in step 208, the CPU 51 waits until predetermined information is input. FIG. 10 illustrates an example of the service designation screen according to the present exemplary embodiment.

As illustrated in FIG. 10, a message prompting the user to designate a cloud service to be applied is displayed on the service designation screen according to the present exemplary embodiment. In addition, on the service designation screen according to the present exemplary embodiment, a list of pieces of information (hereinafter, referred to as “target service name information”) 55A indicating the names of the target contracted services is displayed in a state of being able to be designated.

When the service designation screen is displayed on the display unit 55 of the image forming apparatus 50, the user designates, via the input unit 54, a display area of the name of the cloud service to be applied, among the pieces of displayed target service name information 55A. When any of the display areas is designated by the user, an affirmative determination is made in step 208, and the processing proceeds to step 210.

In step 210, the CPU 51 extracts only the processing-waiting cases registered by the login user (hereinafter, referred to as “target processing-waiting cases”) from the processing-waiting cases corresponding to the target contracted service designated by the user. Then, the CPU 51 performs control so that a processing-waiting case presentation screen having a predetermined configuration is displayed by the display unit 55 by using pieces of information (in the present exemplary embodiment, case names) indicating the extracted target processing-waiting cases, and in step 212, the CPU 51 waits until predetermined information is input. FIG. 11 illustrates an example of the processing-waiting case presentation screen according to the present exemplary embodiment.

As illustrated in FIG. 11, a message prompting the user to designate a processing-waiting case to be applied is displayed on the processing-waiting case presentation screen according to the present exemplary embodiment. In addition, on the processing-waiting case presentation screen according to the present exemplary embodiment, a list of pieces of information (hereinafter, referred to as “pieces of target processing-waiting case name information”) 55B indicating the case names of the target processing-waiting cases is displayed in a state of being able to be designated.

When the processing-waiting case presentation screen is displayed on the display unit 55 of the image forming apparatus 50, the user designates, via the input unit 54, a display area of the case name of the processing-waiting case to be applied (hereinafter, referred to as a “processing target case”), among the pieces of displayed target processing-waiting case name information 55B. When any of the display areas is designated by the user, an affirmative determination is made in step 212, and the processing proceeds to step 212.

In step 214, the CPU 51 executes processing corresponding to the processing-waiting case designated by the user.

For example, in a case where the processing-waiting case is a case for which processing of adding scanned image information obtained by the image reading function of the image forming apparatus 50 is performed, the image forming apparatus 50 reads (scans) a document image in such a manner that the user places a document to be scanned at a predetermined position of the image forming apparatus 50 by using the image forming apparatus 50 and then designates an image reading button. Accordingly, the CPU 51 of the image forming apparatus 50 executes processing of adding the scanned image information obtained by the scanning to information indicating the processing target case.

In step 216, the CPU 51 determines whether or not it is a predetermined end timing as a timing at which the present second information processing is ended. In the case of a negative determination, the processing returns to step 206, and in the case of an affirmative determination, the present second information processing is ended. Note that, in the present exemplary embodiment, a timing at which an instruction input instructing to end the second information processing is given by the user is applied as the end timing, but it goes without saying that the present invention is not limited thereto.

By the above-described second information processing, the processing by the processing-waiting case designated by the user can be continuously performed.

In addition, in a case where the addition of the additional information is performed in many cloud services represented by conventional Kintone (registered trademark) or the like of the related art, it is necessary to perform many steps such as selection of an application and a program, selection of a record, and selection of a field. However, in the information processing system 1 according to the present exemplary embodiment, it is also possible to reduce the time and effort.

Note that, in the above exemplary embodiment, although it has been described that the first information processing is executed in the terminal apparatus 30, the present invention is not limited thereto. For example, the first information processing may be executed by the image forming apparatus 50, or the first information processing may be shared and executed by both the terminal apparatus 30 and the image forming apparatus 50.

In addition, in the above exemplary embodiment, although it has been described that various databases are registered in the license server 10 and the cloud server 80 in a distributed manner, the present invention is not limited thereto. For example, various databases may be collectively registered in any one of these apparatuses.

In addition, in the above-described exemplary embodiment, although it has been described that the list of cloud services in which the processing-waiting cases are registered is preferentially displayed as the selection candidates on the target apparatus by executing the processing of displaying, as the selection candidates, the list of only cloud services in which the processing-waiting cases are registered on the target apparatus, the present invention is not limited thereto. For example, the list of cloud services in which the cases waiting for processing are registered may be preferentially displayed as the selection candidates on the target apparatus by executing processing of emphasizing and displaying, as the selection candidates, the list of cloud services in which the cases waiting for processing are registered on the target apparatus in accordance with a predetermined condition. FIG. 12 illustrates another example of the service designation screen according to this embodiment.

In the example illustrated in FIG. 12, as the predetermined condition, a condition in which the processing-waiting cases are displayed in order of registration dates in the cloud server 80 is applied. As illustrated in FIG. 12, in this example, although a list of the names of all the cloud services supported by the information processing system 1 is displayed, the names are displayed in ascending order of date and times when the processing-waiting cases are registered by the login user. Therefore, in addition to being able to quickly specify the cloud services in which the processing-waiting cases are registered by the login user, the login user can quickly specify the cloud services in which the processing-waiting cases that is highly likely to be processed earlier are registered.

Note that, as the predetermined condition, a condition in which the processing-waiting cases are displayed in the order of delivery dates when the additional processing is performed may be applied. As a result, the login user can quickly specify the cloud services in which the processing-waiting cases are registered by the login user, and can more reliably specify the cloud services in which the processing-waiting cases are registered earlier.

In addition, in these forms, it has been described that the list of cloud services is preferentially displayed as the selection candidate at the top. As the preferential display form, for example, the list of cloud services may be preferentially displayed as the selection candidates by differentiating at least one of the color, the density, and the size from other selection candidates.

In addition, in the above-described exemplary embodiment, the case where the image forming apparatus 50 is applied as the target apparatus has been described, but the present invention is not limited thereto. For example, an image processing apparatus having an image reading function and an image transmitting function may be applied as the target apparatus.

Although an exemplary embodiment has been described above, the technical scope of the present invention is not limited to the scope described in the above-described exemplary embodiment. Various modifications or improvements can be added to the above-described exemplary embodiments without departing from the gist of the invention, and modes to which the modifications or improvements are added are also included in the technical scope of the invention.

In addition, the above-described exemplary embodiments do not limit the invention related to the claims, and all combinations of features described in the exemplary embodiments are not necessarily essential to the solving means of the invention. The above-described exemplary embodiments include inventions in various stages, and various inventions are extracted by combinations of a plurality of disclosed constituent elements. Even if some constituent elements are deleted from all the constituent elements described in the exemplary embodiment, the configuration from which some constituent elements are deleted can be extracted as an invention as long as an effect is obtained.

In addition, in the above exemplary embodiment The processor refers to a processor in a broad sense and includes general-purpose processors (for example, CPUs or the like) and dedicated processors (for example, GPU: Graphics Processing Unit, ASIC: Application Specific Integrated Circuit, FPGA: Field Programmable Gate Array, programmable logic devices, or the like).

In addition, the operation of the processor in the above-described exemplary embodiment may be performed not only by one processor but also by a plurality of processors existing at physically distant positions in cooperation with each other. In addition, the order of the respective operations of the processor is not limited to only the order described in the above exemplary embodiment and may be appropriately changed.

In addition, although the “system” according to the present exemplary embodiment is described as being configurated by a plurality of apparatuses in one example, the “system” may be formed by a single apparatus.

Further, in the above-described exemplary embodiment, the case where the first information processing and the second information processing are implemented by a software configuration using a computer by executing a program has been described, but the present invention is not limited thereto. For example, the first information processing and the second information processing may be implemented by a hardware configuration or a combination of a hardware configuration and a software configuration.

In addition, the configurations of the terminal apparatus 30 and the image forming apparatus 50 described in the above exemplary embodiment are merely examples, and needless to say, unnecessary parts may be deleted or new parts may be added without departing from the scope of the present invention.

In addition, the configurations of the various screens described in the above exemplary embodiments are also examples, and it goes without saying that unnecessary portions may be deleted, new portions may be added, or the layout may be changed without departing from the spirit of the present invention.

Further, the flows of the first information processing and the second information processing described in the above exemplary embodiment are also examples, and it is needless to say that unnecessary steps may be deleted, new steps may be added, and the processing order may be switched, without departing from the spirit and scope of the present invention.

### APPENDIX

(((1)))

An information processing system comprising:
one or more processors configured to:
receive registration, by a user, of cases waiting for processing that are cases for which predetermined additional processing is scheduled to be executed in a target apparatus for any of a plurality of types of cloud services; and
execute processing of preferentially displaying, as selection candidates, a list of cloud services in which the cases waiting for processing are registered among the plurality of types of cloud services on the target apparatus in a case where the user selects the cloud services in which the corresponding cases waiting for processing are registered from the plurality of types of cloud services in the target apparatus in order to execute the additional processing.
   (((2)))

The information processing system according to ((((1))), wherein the additional processing is processing of adding predetermined additional information.

((((3)))

The information processing system according to ((((2))), wherein
the target apparatus is an image processing apparatus having an image reading function, and
the additional information is scanned image information read by the image reading function of the image processing apparatus.
   ((((4)))

The information processing system according to any one of (((1))) to (((3))), wherein the processor is configured to:

execute the processing of displaying the list of cloud services by using cloud services available to a login user who logs in to the target apparatus as targets to be preferentially displayed.

((((5)))

The information processing system according to ((((4))), wherein the processor is configured to:
execute the processing of displaying the list of cloud services by using the cloud services in which the cases waiting processing registered by the login user are registered as targets to be preferentially displayed.
   ((((6)))

The information processing system according to any one of ((((1))) to ((((5))), wherein the processor is configured to:
execute processing of emphasizing and displaying, as the selection candidates, a list of cloud services in which the cases waiting for processing are registered on the target apparatus in accordance with a predetermined condition.
   ((((7)))

The information processing system according to ((((6))), wherein the predetermined condition includes at least one of display in order of delivery dates when the additional processing is performed and display in order of registration dates of the cases.

((((8)))

The information processing system according to any one of ((((1))) to ((((7))), wherein the processor is configured to:
execute processing of displaying, as the selection candidates, a list of only cloud services in which the cases waiting for processing are registered on the target apparatus.
   ((((9)))

The information processing system according to any one of ((((1))) to ((((8))), wherein the processing by the case waiting for processing is processing by a workflow.

(((10)))

The information processing system according to any one of (((1) to (((9))), wherein the processor is configured to:
execute processing of displaying, as the selection candidates, only the cases waiting for processing registered by the user on the target apparatus, among the cases waiting for processing registered in the selected cloud service, in a case where a desired cloud service is selected by the user from the displayed list of selection candidates.

What is claimed is:

1. An information processing system comprising:
one or more processors configured to:
receive registration, by a user, of cases waiting for processing that are cases for which predetermined additional processing is scheduled to be executed in a target apparatus for any of a plurality of types of cloud services; and
execute processing of preferentially displaying, as selection candidates, a list of cloud services in which the cases waiting for processing are registered among the plurality of types of cloud services on the target apparatus in a case where the user selects the cloud services in which the corresponding cases waiting for processing are registered from the plurality of types of cloud services in the target apparatus in order to execute the additional processing.

2. The information processing system according to claim 1, wherein the additional processing is processing of adding predetermined additional information.

3. The information processing system according to claim 2, wherein
the target apparatus is an image processing apparatus having an image reading function, and
the additional information is scanned image information read by the image reading function of the image processing apparatus.

4. The information processing system according to claim 1, wherein the processor is configured to:
execute the processing of displaying the list of cloud services by using cloud services available to a login user who logs in to the target apparatus as targets to be preferentially displayed.

5. The information processing system according to claim 4, wherein the processor is configured to:
execute the processing of displaying the list of cloud services by using the cloud services in which the cases waiting processing registered by the login user are registered as targets to be preferentially displayed.

6. The information processing system according to claim 1, wherein the processor is configured to:
execute processing of emphasizing and displaying, as the selection candidates, a list of cloud services in which the cases waiting for processing are registered on the target apparatus in accordance with a predetermined condition.

7. The information processing system according to claim 6, wherein the predetermined condition includes at least one of display in order of delivery dates when the additional processing is performed and display in order of registration dates of the cases.

8. The information processing system according to claim 1, wherein the processor is configured to:
execute processing of displaying, as the selection candidates, a list of only cloud services in which the cases waiting for processing are registered on the target apparatus.

9. The information processing system according to claim 1, wherein the processing by the case waiting for processing is processing by a workflow.

10. The information processing system according to claim 1, wherein the processor is configured to:
execute processing of displaying, as the selection candidates, only the cases waiting for processing registered by the user on the target apparatus, among the cases waiting for processing registered in the selected cloud service, in a case where a desired cloud service is selected by the user from the displayed list of selection candidates.

11. A non-transitory computer readable medium storing a program causing a computer to execute a process for information processing, the process comprising:
receiving registration, by a user, of cases waiting for processing that are cases for which predetermined additional processing is scheduled to be executed in a target apparatus for any of a plurality of types of cloud services; and
executing processing of preferentially displaying, as selection candidates, a list of cloud services in which the cases waiting for processing are registered among the plurality of types of cloud services on the target apparatus in a case where the user selects the cloud services in which the corresponding cases waiting for processing are registered from the plurality of types of cloud services in the target apparatus in order to execute the additional processing.
